(19) United States
(12) Patent Application Publication
(10) Pub. No.: US 2002/0154163 A1
(43) Pub. Date: Oct. 24, 2002

(54) Advertising system for interactive multi-stages advertisements that use the non-used areas of the browser interface

(75) Inventor: Alon Melchner, Lod (IL)

Correspondence Address: DR. MARK FRIEDMAN LTD., C/O BILL POLKINGHORN, DISCOVERY DISPATCH, 9003 FLORIN WAY, UPPER MARLBORO, MD, 20772, US

(73) Assignee: Oak Interactive Ltd.

(21) Appl. No.: 10/124,408

(22) Filed: Apr. 18, 2002

Related U.S. Application Data
(60) Provisional application No. 60/284,186, filed on Apr. 18, 2001.

(51) Int. Cl. G09G 5/00

(52) U.S. Cl. 345/749; 345/748; 345/709

(57) ABSTRACT

A system and method for enabling user-controlled interactive online advertisements in typically under-utilized areas of the browser interface. These advertisements are provided in interactive, sliding boxes (Jumpslides), for the purpose of enhancing marketing campaigns. Jumpslides provide 100% exposure of advertisements, and generate user-driven instant progression of multi-slide and multimedia advertisements. Jumpslides enable the usage of borderless and headerless windows for customized advertisements. These windows operate independently of existing browser windows, and appear as non-intrusive multimedia pop-up windows that are fully interactive.

### FIELD AND BACKGROUND OF THE INVENTION

1. Field of the Invention

The present invention relates to online advertising, and in particular, to a system and method for creating interactive multi-stages advertisements.

2. Description of the Related Art

The recent developments in Internet communication and the access of hundreds of millions of users to Internet content has caused a revolution in Commercial advertising. This online advertising includes delivering advertisements to Internet users via Web sites, e-mail, ad-supported software and Internet-enabled cell phones. Organizations that provide Internet advertising either sell the ads and pay the Web or software publisher to display them, or they provide software tools and/or advertising servers (Adsevers) that enable an organization to deliver the advertisements itself.

The Internet has provided a new channel for advertisers, enabling both mass and personalized advertisements to Internet users. Typical online advertisements include banners, Rich media advertisements, Pop-Up advertisements and email campaigns. Banners are currently the most ubiquitous type of advertising, containing graphic images used on Web sites to advertise a product or service. Banner ads come in numerous sizes, but are often rectangles 460 pixels wide by 60 pixels high, 460×55 or 392×72. Banners are usually positioned in the user's browser window, in the place determined by a particular Web site. Unfortunately there are limits to the advertising space available on a typically content full Web page, and there is certainly a need to find new ways of displaying advertising content. More recent banner and other type advertisements have begun to use flash multimedia in the advertisements, which appear on top of web pages as a floating animation. This disturbs many users, since it takes longer to load Web pages and is highly intrusive, appearing even if the user does not desire the advertisements and can hide the content.

Pop-ups are larger advertisements than banners, and they opens a window that appears on top of the web site on which the user is navigating on. These advertisements are also highly intrusive, appearing even if the user does not desire the advertisements, thereby often resulting in the user immediately close them, thereby not achieving a full exposure.

There is thus a widely recognized need for, and it would be highly advantageous to have, a means that can enable interactive online advertising that can be controlled by the user, which utilizes the non-used areas of the browser interface, and guarantees high exposure advertising.

### SUMMARY OF THE INVENTION

According to the present invention there is provided a system for enabling interactive online advertisements in typically under-utilized areas of the browser interface, and the user-driven control of these advertisements in interactive, sliding boxes, for the purpose of enhancing marketing campaigns and on the spot mini-sites, interaction with the ad and other features that makes it a one stop, full marketing and advertising campaign from the high exposure rate to the final strategy of the campaign such as sign in, print a coupon or order a product.

The advertisements are provides as programs (Jumpslides) that are contained on a server, and that are generated by scripts placed within Web pages. Upon displaying such a page on a user device, the script is launched which communicated with the server is order to download the program, to the user device. The program is not displayed on the user device until it is fully downloaded. When ready, it is launched by initially sliding a mini window as a teaser for the advertisement. The user may click on the teaser if interested, which will subsequently display the next slide of the advertisement.

### BRIEF DESCRIPTION OF THE DRAWINGS

The principles and operation of a system and a method according to the present invention may be better understood with reference to the drawings and the accompanying description, it being understood that these drawings are given for illustrative purposes only and are not meant to be limiting, wherein:

FIG. 1 is an illustration of the components according to the present invention.

FIG. 2 is an illustration of the teaser advertisement that is displayed on a typical Web page.

FIG. 3 is an illustration of a typical Jumpslide advertisement as displayed in a browser window.

FIG. 4 provides a flow chart describing the running procedure of a typical Jumpslide advertisement.

### DESCRIPTION OF THE PREFERRED EMBODIMENT

The present invention relates to a system and method for enabling interactive user-driven online advertisements in typically under-utilized areas of the browser interface. The user can control the expansion, minimization and continuation of these advertisements, which are in the form of interactive, sliding boxes, which remain open until closed by the user, even if the browser has been closed.

The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

Specifically, the present invention can be used to provide interactive multimedia boxes (hereinafter referred to as “Jumpslides”) of different sizes, that slide into a users output device from the top, bottom, left or right side of the screen, initially appearing in parts of the interface that are conventionally not-used for dynamic content. A Jumpslide is an independent program that is loaded from a server into the user's browser software, enabling floating an interactive box over the browser and displaying different content than the browser below it. The program in effect manages a borderless and headerless browser window, or system window, which can be controlled by the user, and can be totally filled with advertisement content. These boxes offer an effective way of exposing advertisements, and other marketing tools such as forms, e-commerce content and games etc., on top of existing Web page content. The boxes are floating windows that appear to the user in a complete, fully loaded form, independent of the conventional browser window. These windows initially appear as teasers (minimal size windows in typically non-utilized areas of the user's screen) that remain for a determinable time period, and then disappear unless interacted with by the user. The user can alternatively interact with them, causing the full advertising content to be displayed. The script that controls these boxes enables them to change their size and proportion, in order to offer more information, according the user's interest or choice. These boxes can also be interacted with manually, by dragging their extensions (to enlarge a box), clicking on the boxes (to link to a Web site, interact with the box content etc.), speaking voice commands, typing in content and by other means.

The Jumpslide technology offers 100% exposure of advertisements, because it is fully loaded before display and displays even if the browser window has been subsequently closed. Furthermore, since the Jumpslides can be controlled (expanded etc.) by the user, and all user actions can be monitored by the server, it can be accurately determined which advertisements have been exposed to the user, and to what degree. In addition, the Jumpslide generates user-driven instant progression of advertisements, in order to save time for Internet users and to offer all the relevant information for an advertisement in one place, without requiring of the user to leave the page that they are in. For example, a car advertisement may include several pages, one following the next, so that each one can provide the viewer with relevant information such as a picture, features, advantages, video footage and cost. Such a stream of boxes can resemble an interactive presentation, and therefore present a dynamic, multimedia, interactive advertisement opportunity, with or without user interaction. These, advertisements, or content packages, can be programmed to appear on the users output device (screen) in areas such as the spaces ordinarily reserved for option menus, links buttons, scroll bars, shortcuts etc, so as not to disturb the main content areas of the page being viewed.

The present invention therefore provides an alternative means of advertising that guarantees precise numbers of exposures in currently under-utilized high-power advertising space. Furthermore, the resulting advertisements are customized, high quality, multimedia, interactive advertisements.

The principles and operation of the system and a method according to the present invention may be better understood with reference to the drawings and the accompanying description, it being understood that these drawings are given for illustrative purposes only and are not meant to be limiting, wherein:

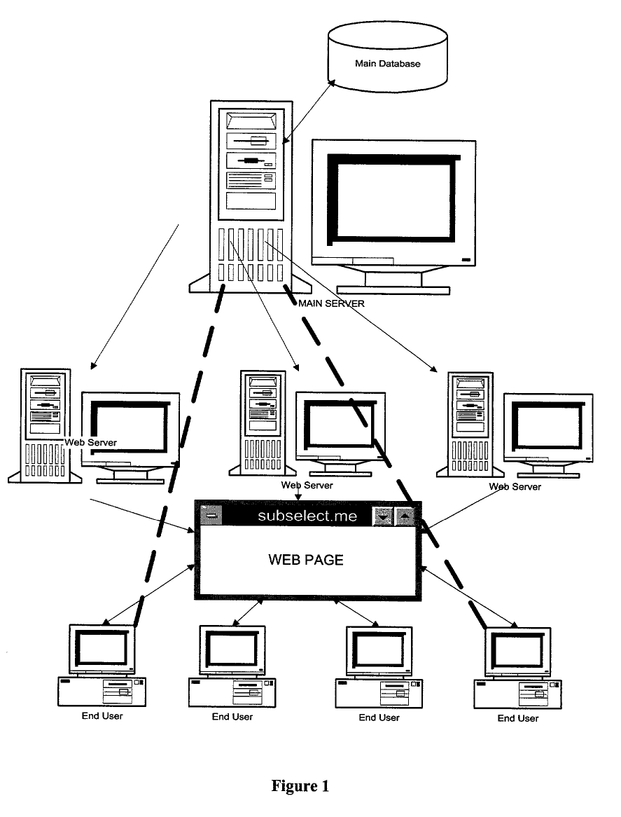

As can be seen with reference to FIG. 1, the Jumpslide advertising system, according to a preferred embodiment, comprises the following elements:

1. A main server 11 that contains the following:

i) Codes for activating the sliding boxes from remote servers, and for controlling the progression of the advertisements, limiting the views per user, managing the advertising client etc.).

ii) A preloading module for controlling advertisements over the web by completely preloading advertisements before they appear, and then exposing them within borderless and headerless floating boxes. The advertisement starts to preload when the user access a relevant Web page, thereby activating a first script in the code. The server then approves the advertisement exposure, loads the advertisement (program), and when fully loaded, activates a second script that exposes the loaded advertisement.

iii) A site engine that distributes Web site information on top of a Jumpslide box. This information enables a Web site to use the floating box to display data read directly form the Web site database for the purpose of displaying hot news, alerts, special offers etc.

2. A database for storing all the advertisement content, information needed to control and manage the advertisements, statistics, user profiles and any other relevant data.

3. Web Servers for serving the Web page content to users. Web servers are optionally equipped with a user-friendly wizard that provides a simple means of generating the relevant scripts to be added to the Web site content, for initiating and running the advertisements on end-user terminals. This wizard is a stand-alone program that is used by clients (such as Web server administrators) without requiring the aid of the Jumpslide development and support team.

4. End users who access the Web page content, thereby initiating the loading of Jumpslides, and subsequently control the exposure of the Jumpslides. As can be seen in the Figure, the end users may run the advertising programs either directly through the remote servers, or through initial contact with the remote server and subsequent communication with the main server.

Advertisements that are promoted according to the system of the present invention can include sound, video, or any other multimedia means. Furthermore, these advertisements can displayed in user browser windows when users are navigating across Internet content, using desktops, WAP enabled devices, PDA's, cellular phones, wireless devices, Web TV etc. In order to deliver appropriate advertising content to various devices, it is necessary to define the advertisements according to device type. If, for example, a sliding box series is designed for PDAs, it can be defined as such in the Database, such that it will only be downloaded by a compatible device.

In addition, the present invention enables the management of advertisements, according to chosen time periods on specific sites. For example, an advertisement can be configured to display whenever a specific user or general users have entered a specific Web site. An advertisement administrator using the Jumpslide system may further be determined to deliver a specific advert to a user only after a certain time has passed (1 hour, 6 hours, a day etc.). Such advertisements are typically configured to slide out of the user's screen after a few seconds, thereby disappearing from the user's screen, if no effort was made by the user to interact with the advertisement.

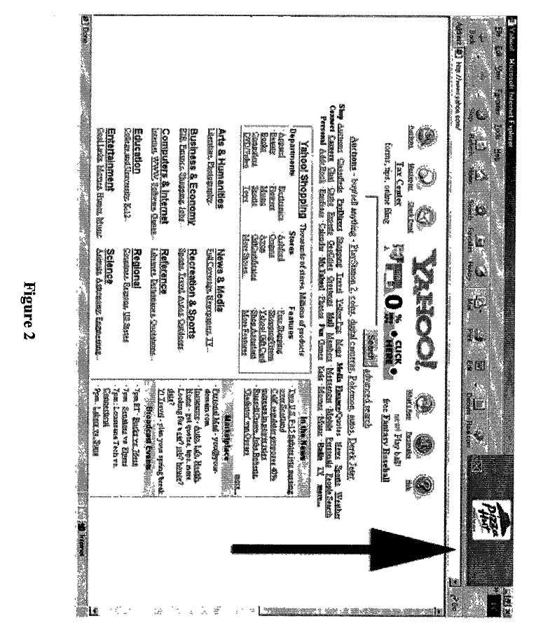

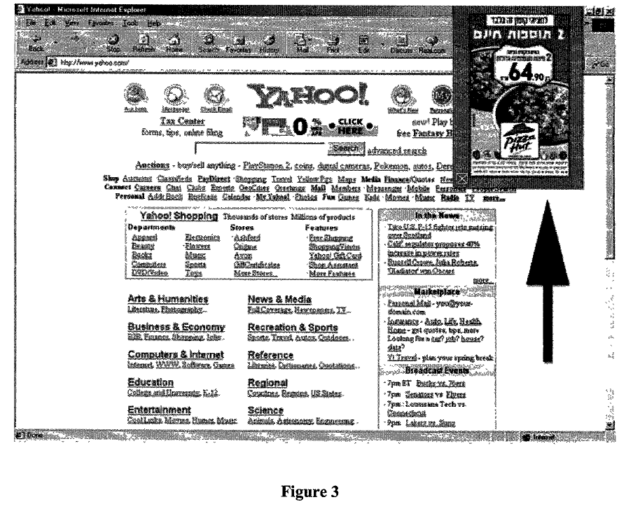

Once a user accesses a Web site where the Jumpslide system is operative, the following occurs: As can be seen in FIG. 2, a box slides in from above and stops at the empty or non-utilized gray area on the browser window. Following this, as can be seen in FIG. 3, once the user interacts with the box, by clicking on it or dragging it, the box grows or continues to slide down until a full advertisement appears. When finished it closes and reappears only after a predefined time. In the case of a multi-slide advertisement, a similar process may be driven by the end-user, thereby controlling the exposure of multi-slide advertisements.

How the System Works

The heart of the Jumpslide advertising system, according to a preferred embodiment, is the main server. The main server is configured with the following data:

All the campaign information of the various campaigns (client, ads, timing, media destinations etc.), which is contained in the system database (within or connected to the main server);

A code (typically Java Script) for adding to the relevant HTML page code, or inside a banner or a banner system, to activate and control the sliding box advertisements. The code (Activation code) is used to activate the Jumpslide box for the first time, or to activate the advertisements specific functions that will be used when the advertisement appears. After being activated, the code optionally loads the rest of the scripts and commands from the loaded program, and sends to the database important data such as exposure verification, user click-throughs etc.

A user synchronization module that matches specific advertisements to specific users or user types. This module enables configuration of user profiles for each end user or type of user (according to type of device or services required). When an end-user accesses a relevant Web site, they are identified (by means of a cookie type tool) and the server subsequently processes the user profile so as to determine the appropriate distribution of advertisements to that specific user. This may alternatively be executed on a subscriber type basis, such that users can determine their own profiles, which are subsequently stored on the server. In the case of user profiles determined according to user-type devices, all users of specific types of devices, such as PDAs, will received one kind advertisement, while all users of other device types, such as desktop computers, will receive an alternative version (typically more graphically intense) of the advertisement. This module can also track the advertisement distribution to specific users, in order to determine the intervals between advertisements, appropriate times to send advertisement, starting times, progress and ending times for particular campaigns, and which advertisements have not been seen by specific subscribers.

A scripting module is used by the main server to provide clients (typically portals, Web sites or any other interactive media players that can promote the advertisements) with a very small script that contains only the basic media information required to activate the entire Jumpslide program from the main server, in order to run an advertisement. The script checks the cookie inside the user computer and decides, according to the predefined schedule, whether to offer an advertisement to the specific user. In the case where an advertisement should be run, the scripting module loads the advertising program from the server.

A statistics engine that stores and analyzes relevant information concerning subscribers and advertising campaigns. Information that is recorded and analyzed includes advertisement click through rates, interactivity rates, success rates of various programs etc. The statistic engine can produce meaningful information that describes campaign successes or failures, ratings, behavior and unique user numbers that were exposed to an advertisement etc. This information can be provided to system managers, subscribers and clients (the media).

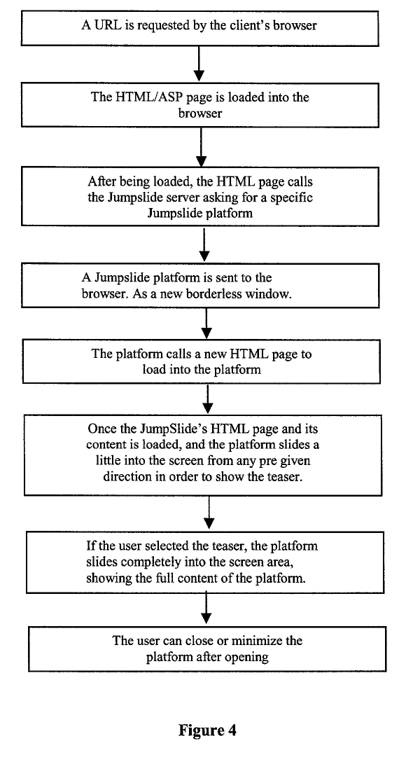

Following configuration of the main server, the Jumpslide application is ready to run. The actual procedure for operating the system and receiving Jumpslides is as follows, as can be seen with reference to FIG. 4.

1. An end-user enters a Web site URL during navigation, by the client's browser;

2. The requested HTML page or Active Server Page (ASP) is loaded onto the browser, so that it can be displayed to the user;

3. After a relevant page has loaded (a page that is configured to display a Jumpslide), a script embedded in the downloaded HTML page calls the server (typically the main Jumpslide server, but optionally any other server that has been provided with the Jumpslide platform) asking for a specific Jumpslide program to be executed;

4. The relevant Jumpslide program, as requested by the script in the HTML page, is downloaded to the user device, to be displayed by the user browser software. The program, however, does not display on the user device until it is fully loaded.

5. The program, when fully loaded, activates a script that launches a the Jumpslide (it is typically a borderless and headerless HTML-based window that is independent of the original HTML page downloaded).

6. Once the Jumpslide's HTML page and its content is loaded and launched, the program slides a little into the screen from any pre-configured direction (on top of the browser window) in order to show the Jumpslide teaser. The teaser is typically displayed on a part of the user interface that is non-utilized for dynamic content, as determined by the content providers.

7. If the user moves the mouse pointer over the teaser, or clicks on the teaser, the program slides completely into the screen area, thereby opening up a larger image with additional or new content.

8. The same pattern may continue, whereby the user can choose to move the pointer over the current slide (box), which triggers the next slide in the series, thereby displaying the full content of the multi-slide program to the user.

9. The user can close or minimize the program after opening. If the user does not move over or click on the teaser or current slide, the teaser or slide will typically disappear after a determined period of time.

The actual scripts and commands that are generated in the above process of are as follows:

1. The host HTML (original Web page content source) uses a script tag in the end of its body section (just before </body>) in order to call the Jumpslide server. The script tag, according to a preferred embodiment of the present invention, is provided by the Jumpslide server. In an additional embodiment, wherein the Jumpslide platform is provided to a client server, the tag can be generated from the remote server. In addition, a client wizard may be provided to enable user-friendly generation and configuration of the script tag.

2. Once the host (currently viewed) HTML page calls the server to request the Jumpslide program, the server runs an ASP page that dynamically generates a script that:

i) Checks if a program can be loaded into the end user browser, according to the following criteria:

A. If the user did not see the particular Jumpslide before (or not since a determined interval);

B. If the host HTML site is allowed to load a Jumpslide (if the Web site is a subscriber/user of the Jumpslide advertising system)

ii) Checks the campaign parameters in the database and opens the program where relevant (if the time and date are relevant, the user device fits the particular Jumpslide configuration, and the user profile is matched to the type of Jumpslide advertisement being served etc.).

3. The ASP page then initiates an embedded JavaScript or VBScript that opens the program, by opening a new window in a full screen mode (typically a borderless and headerless window).

i) Once the program is opened, it immediately goes behind the hosting HTML page and calls the Main server for a new HTML page (containing the Jumpslide content) to be loaded into the program, The program stays out of sight until the new HTML page is fully loaded.

ii) Once the program new HTML page is loaded, it takes control of the Jumpslide's behavior and acts in the following manner:

A. Sets the program position out of the screen, so that it cannot yet be seen by the user.

B. Sets the program display sizes.

C. Completely loads the advertisement content into the program window

4. When the advertisement is loaded, the program slides a little into the screen area in order to show a part of the advertisement that is used as a teaser. The advertisement reports to the Jumpslide server if the teaser was viewed.

5. When the user moves the mouse pointer over the teaser or clicks the teaser, the following actions happen:

i) The Jumpslide server receives a report about the user interaction with the teaser.

ii) The program slides fully into the screen, showing the full advertisement (or the next part thereof):

A. Being a browser window, the Jumpslide program can host movies, flash, HTML forms etc. The browser reports to the server about any further action that is made with the program.

B. The program can return to its original place (hidden behind the browser window) if:

1. the user clicks the minimize button; and/or

2. a timer signals that the display time of the advertisement has ended

6. The program can be closed (ended) by the user by clicking on a “close” button that is shown on the advertisement.

7. The program can be resized dynamically in order to support a larger content if needed.

8. The program can be opened from any direction: up, down, left and right.

Advantages:

The present invention generates advertisements that guarantees 100% exposure, as the Jumpslide system launches only filly loaded Jumpslides. Furthermore, these slides are controlled by the user, who thereby chooses whether to open additional slides. The server receives direct feedback from the users, and can therefore determine precise exposure of slides. These advertisements, furthermore, are filly displayed to the user without requiring the user to leave the current. Even when the user closes the current browser window, the fully loaded advertisement can appear.

Alternate Embodiments

Several other embodiments are contemplated by the inventors. For example 1. Providing the Jumpslide platform to a remote Web server, such that all the Main server functions, including script provision, campaign maintenance, program downloading, statistical analyses etc. can be run directly by the remote server.

2. Using the boxes (Jumpslides) of the present invention as a means to connect the client to a company by a phone call. This is achieved by connecting the program to a phone call provision Services Company. When a user submits a subscription form on the Jumpslide with their phone number on it, the service giving company connects the submitted phone with any pre given phone (usually the advertising company).

3. Using the boxes (Jumpslides) of the present invention as a means to transfer a coupon/text/code in the form of an SMS message to a user. This is achieved when a user clicks on the box (Jumpslide), thereby connecting the program to relevant Services Company. By submitting a form on the Jumpslide with the user's phone on it, the service giving company receives the data to be transferred and sends it as a SMS message to any SMS compliant cellular telephone.

4. Using the boxes (Jumpslides) of the present invention as a means to read the latest sales from the client's server, and offer instant ordering directly from the page the surfer is on, without requiring the user to leave the page. This is achieved by connecting the Jumpslide directly to the advertising client sales server's database and ordering pages.

The foregoing description of the embodiments of the invention has been presented for the purposes of illustration and description. It is not intended to be exhaustive or to limit the invention to the precise form disclosed. It should be appreciated that many modifications and variations are possible in light of the above teaching. It is intended that the scope of the invention be limited not by this detailed description, but rather by the claims appended hereto.

What is claimed is:

1. A system for enabling customized advertisement online, using parts of the browser screen un-utilized for dynamic content, comprising the components described herein.
a main server for providing the advertisement program, said program providing scripts for loading, launching and managing advertisements;
a remote server for serving Web page content to users.

2. A method for enabling customized advertisement online, using parts of the browser screen un-utilized for dynamic content, comprising:
entering a script into a Web page, by a customer;
accessing said Web page, by an end-user;
launching said script, said script initiating communication with said main server;
loading an advertising program from said main server to a user device;
completely loading said program;
launching a teaser window on said user device.

3. The method of claim 2, further comprising interacting with said teaser window to generate display of full advertisement.

4. A method for providing user-driven multimedia advertisement online, comprising:
running an advertising program preloaded into a user device;
launching a borderless and headerless window for displaying advertising content;
providing navigation tools for enabling a user to control said advertising content.

5. The method of claim 4, wherein said pre-loaded advertisements providing customized user-determined pop-up advertisements.

6. The method of claim 4, wherein said advertisements are independent of existing browser windows.

7. A method for providing multi-stage interactive advertisements online, comprising:
accessing a Web page that has an embedded advertising script, by an end-user;
launching said script, said script initiating communication with said main server;
loading an advertising program from said main server to a user device;
launching a teaser window on said user device, said teaser window having navigational options for enabling user control of said window;
if user interacts with said window, launching an additional window that further exposes the interactive advertising content.

8. The method of claim 7, wherein said main server is a remote server.

9. The method of claim 7, wherein said user interaction with said window is selected from the group of actions consisting of connecting to a destination telephone, communicating an SMS message to a cellular phone, and acquiring pages on demand from a company Web server.
